(19) United States
(12) Patent Application Publication
(10) Pub. No.: US 2010/0074511 A1
(43) Pub. Date: Mar. 25, 2010

(54) MASK INSPECTION APPARATUS, AND EXPOSURE METHOD AND MASK INSPECTION METHOD USING THE SAME

(75) Inventors: Shuichi TAMAMUSHI, Kanagawa (JP); Noriyuki Takamatsu, Tokyo (JP); Takehiko Nomura, Kanagawa (JP); Masahiro Iiri, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: NuFlare Technology, Inc., Numazu-shi (JP)

(21) Appl. No.: 12/561,000

(22) Filed: Sep. 16, 2009

(30) Foreign Application Priority Data
Sep. 22, 2008 (JP) 2008-242596
Feb. 17, 2009 (JP) 2009-034570

(51) Int. Cl. G06K 9/00

(52) U.S. Cl. 382/141

(57) ABSTRACT

The present invention provides a mask inspection apparatus and method capable of inspecting masks used in double patterning with satisfactory accuracy.

Optical images of two masks are acquired (S100). The acquired optical images of the two masks are combined together (S102). Relative positional displacement amounts of patterns of the first mask and patterns of the second mask are measured at the combined image (S104). The measured relative positional displacement amounts are compared with standard values to thereby determine whether the two masks are good (S106).

### BACKGROUND OF THE INVENTION

1. Field of the Invention

The present invention relates to a mask inspection apparatus for inspecting a defect of a mask, and an exposure method and a mask inspection method which use the mask inspection apparatus.

2. Background Art

A reticle or photomask (hereinafter called “mask”) is used in a manufacturing process of a semiconductor device to form each pattern on a substrate. If a mask is defective, a defect is transferred onto a pattern. To avoid such undesirable transfer, a mask defect inspection is generally carried out with the use of an inspection apparatus.

A Die-to-Die inspection and a Die-to-Database inspection are known in the art as mask inspection methods.

In the Die-to-Die inspection, optical images of the same pattern written at different positions of one mask are compared with each other. On the other hand, in the Die-to-Database inspection, a reference image generated from design data (CAD data) used upon mask creation and each of optical images of patterns written onto a mask are compared with each other.

In a mask inspection apparatus described in, for example, a patent document 1 (Japanese Patent Laid-open No. 2006-266864), a stage is moved in X and Y directions in a state of holding one mask thereon. Optical images are acquired while the positions of the stage measured by laser interferometers are used. Each of the acquired optical images and a predetermined reference image are compared with each other. When these optical and reference images are compared with each other, alignment for causing the positions of both images to coincide with each other is carried out. Positional displacement amounts of both images are determined to perform the alignment. Incidentally, these determined positional displacement amounts have conventionally been not used for purposes other than the alignment.

FIG. 13 is a diagram showing a configuration of a conventional mask-related production line. The line 301 shown in FIG. 13 is equipped with a writing apparatus (electron beam writing apparatus, for example) 302, a position measurement apparatus 303, a mask inspection apparatus 304, a wafer exposure apparatus (also called “scanner”) 305 and a measurement apparatus (also called “wafer metrology apparatus”) 306.

For example, mask blanks in which a Cr film corresponding to a lightproof or light-shielding film is formed in a glass substrate, and a resist is applied onto the Cr film are brought onto a stage of the writing apparatus 302. The writing apparatus 302 writes patterns in the mask blanks using an electron beam that is one example of a charged particle beam. A mask with a resist pattern formed therein is brought to the position measurement apparatus 303. The position measurement apparatus 303 measures the position of a predetermined mark (known cross mark, for example) formed at a predetermined position of a mask surface. When the measured position of mark is significantly displaced from a standard position, the mask is determined to be a defective item.

The mask determined to be non-defective by the position measurement apparatus 303 is brought to the mask inspection apparatus 304. The mask inspection apparatus 304 acquires each optical image of the mask and compares the acquired optical image and a reference image corresponding to a standard image to thereby detect a defect on the mask. The mask inspection apparatus 304 inspects whether pattern shapes coincide with each other between the optical image and the reference image. Therefore, even a mask having passed the inspection of a defect by the mask inspection apparatus 304 has a possibility that it has a pattern's positional displacement caused by pattern writing accuracy of the writing apparatus.

Incidentally, since only the position of the predetermined mark is measured by the position measurement apparatus 303, the position measurement apparatus 303 cannot measure such pattern's positional displacement.

Meanwhile, with miniaturization and higher densification of circuit patterns for a recent semiconductor device, there has been a strict demand for alignment accuracy of patterns. When the alignment accuracy of the patterns, i.e., the amount of positional displacement of each pattern increases, a reduction in the yield of a semiconductor device formed in a wafer occurs.

Thus, as shown in FIG. 13, the mask having passed the defect inspection is set to the wafer exposure apparatus 305. Tentative exposure (hereinafter called “temporary exposure”) is performed on a measuring wafer different from a product wafer. The amount of positional displacement of each resist pattern formed by the temporary exposure is measured by the measurement apparatus 306. The positional displacement amount measured by the measurement apparatus 306 is inputted to a positional displacement amount input part 305a of the wafer exposure apparatus 305. In the wafer exposure apparatus 305, an exposure position controller 305b controls an optical system to eliminate the inputted positional displacement amount. Since the positional displacement of the resist pattern on the wafer can be reduced by the control of the optical system, the yield of the semiconductor device can be enhanced.

The method adopted in the line 301 is however accompanied by a problem that since there is a need to perform the temporary exposure, the time is taken until mass production is started by the wafer exposure apparatus 305 using the mask having passed the defect inspection of the mask inspection apparatus 304. Since the measurement of the positional displacement amount of each resist pattern formed by the temporary exposure is affected by the roughness of the resist pattern and process errors of development, it is difficult to detect the positional displacement amount with satisfactory accuracy.

As mentioned above, the miniaturization and higher densification of the circuit patterns for the semiconductor device have been advanced. Resolution enhancement with the shortening of an exposure wavelength is approaching its limit. As its measure, a double patterning or double exposure technology has been studied.

Upon double patterning, a pattern is divided into two masks 101A and 101B as shown in FIG. 14. Exposure is performed twice using these masks 101A and 101B to form high-density patterns (e.g., line-and-space patterns each having a fine pitch).

Meanwhile, when both of line patterns written on two masks cause positional displacements caused by the pattern writing accuracy of a writing apparatus (electron beam writing apparatus, for example), a line pattern L1 transferred with a first mask and a line pattern L2 transferred with a second mask might come closer than design positions indicated by chain double-dashed lines as shown in FIG. 15. In this case, a malfunction occurs in that the width Ws of space defined between these line patterns L1 and L2 becomes narrower than a design value.

In an etching process and a development process each corresponding to a mask's manufacturing process, the line width of each chrome pattern becomes thicker than the design value due to process errors.

There is generally a tendency that the line width of a line pattern existing in the center of a mask becomes thicker than that of a line pattern existing in the end of the mask. Therefore, a space width Ws taken where patterns thick in line width located in the center of a mask are transferred by double patterning as shown in FIG. 16A becomes narrower than a space width Ws taken where patterns at the end of the mask are transferred by double patterning as shown in FIG. 16B.

In the mask inspection method described in the patent document 1, however, the comparison of pattern shapes between the optical and reference images of one mask has mainly been performed, and the detection of the pattern's positional displacement and dimensional error has been allowed to some extent. Alignment of the patterns of the two masks 101A and 101B for double patterning is required with a high accuracy of about 2 nm to 3 nm. It was thus difficult to inspect the two masks used in double patterning with satisfactory accuracy in the conventional method.

The present invention has been made in view of the foregoing problems. That is, a first object of the present invention is to provide a mask inspection apparatus capable of shortening the time taken until mass production is started by a wafer exposure apparatus using a mask having passed a defect inspection of the mask inspection apparatus, and an exposure method using the mask inspection apparatus.

A second object of the present invention is to provide a mask inspection apparatus and method capable of inspecting masks used in double patterning with satisfactory accuracy.

Other objects and advantages of the present invention will become apparent from the following description.

### SUMMARY OF THE INVENTION

According to one aspect of the present invention, a mask inspection apparatus comprises an optical image acquisition part for acquiring optical images of a mask, a reference image generation part for generating reference images of the mask from design data of the mask, a positional displacement amount measurement part for measuring positional displacement amounts between the optical and reference images, and a positional displacement amount output part for outputting the positional displacement amounts to a wafer exposure apparatus and/or a writing apparatus.

According to another aspect of the present invention, in an exposure method, positional displacement amounts between optical images of a mask and reference images obtained from design data of the mask is acquired by the mask inspection apparatus according to the present invention. The acquired positional displacement amounts is inputted to an exposure apparatus. An optical system of the exposure apparatus is controlled based on the inputted positional displacement amounts to thereby perform exposure to a wafer.

According to othere aspect of the present invention, a mask inspection apparatus comprises an optical image acquisition part for acquiring optical images of a plurality of masks, an optical image combining part for combining the optical images of the masks, which have been acquired by the optical image acquisition part, a positional displacement amount measurement part for measuring relative positional displacement amounts of patterns of the masks at an image combined by the optical image combining part, and a comparison part for comparing the positional displacement amounts measured by the positional displacement amount measurement part with standard values respectively.

According to other aspect of the present invention, in a mask inspection method for inspecting first and second masks for double patterning, optical images of the first and second masks are acquired respectively. The optical image of the first mask and the optical image of the second mask are combined while they are being brought into alignment. Relative positional displacement amounts of each pattern of the first mask and each pattern of the second mask is measured at the combined image. The measured positional displacement amounts are compared with standard values respectively.

### BRIEF DESCRIPTION OF THE DRAWINGS

FIG. 1 is a diagram showing a configuration of a mask-related production line in a first embodiment of the present invention.

FIG. 2 is a conceptual diagram showing a configuration of the mask inspection apparatus 10 in the first embodiment of the present invention.

FIG. 3 is a conceptual diagram showing inspection stripes of the mask 101.

FIG. 4A and FIG. 4B are diagrams explaining a method of measuring of positional displacement amounts between reference images and optical images.

FIG. 5 is diagram explaining a method of measuring of dimensional error amount between a pattern of reference image and a pattern pf optical image.

FIG. 6 is a conceptual diagram showing a configuration of a mask inspection apparatus 100 according to the second embodiment of the present invention.

FIG. 7 is a conceptual diagram explaining a measurement of positional displacement amounts of patterns necessary for alignment.

FIG. 8 is a conceptual diagram explaining a measurement of relative positional displacement amounts at a combined image.

FIG. 9 is a flowchart explaining a mask inspection method according to the second embodiment of the present invention.

FIG. 10 is a diagram showing one example applied the present invention to the Die-to-Die inspection.

FIG. 11 is a diagram showing another example applied the present invention to the Die-to-Die inspection.

FIG. 12 shows an example in which mask inspections are performed using two inspection apparatuses.

FIG. 13 is a diagram showing a configuration of a conventional mask-related production line.

FIG. 14 is an outline diagram showing two masks using on double patterning.

FIG. 15 is a conceptual diagram explaining the case that a space width between transferred patterns becomes narrow by positional displacements of mask patterns.

FIG. 16 is a conceptual diagram explaining the case that a space width between transferred patterns becomes narrow by process error.

### DETAILED DESCRIPTION OF THE EMBODIMENTS

Embodiments of the present invention will hereinafter be described in detail.

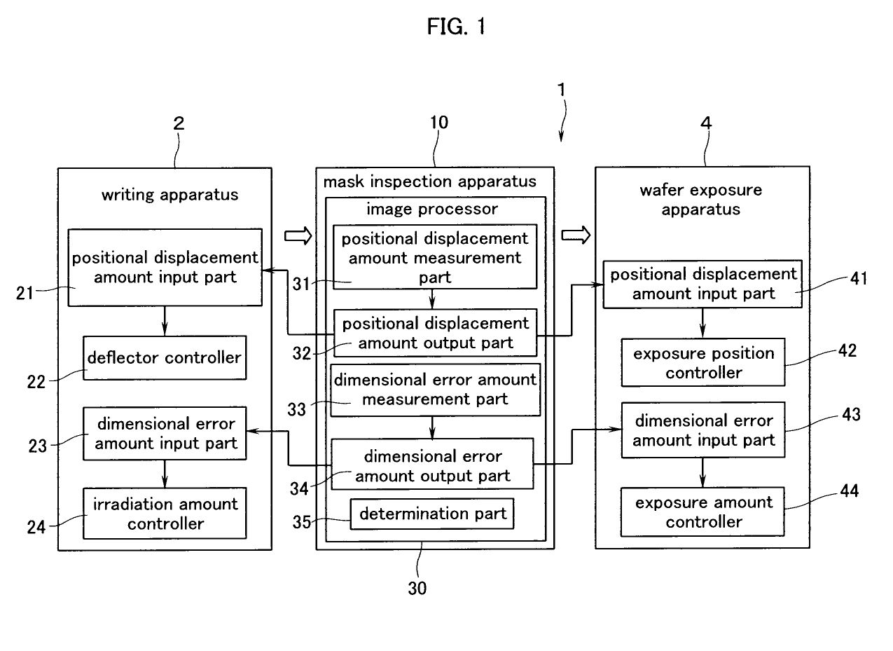

FIG. 1 is a diagram showing a configuration of a mask-related production line in a first embodiment of the present invention. The mask line 1 shown in FIG. 1 is equipped with a writing apparatus (Charged particle beam writing apparatus like an electron beam writing apparatus, for example) 2, a mask inspection apparatus 10 and a wafer exposure apparatus 4 using a reduction or scale-down projection technology.

The mask inspection apparatus 10 is equipped with an image processor 30. The image processor 30 includes a positional displacement amount measurement part 31, a positional displacement amount output part 32, a dimensional error amount measurement part 33, a dimensional error amount output part 34 and a determination part 35. Other detailed configurations of the mask inspection apparatus 10 will be explained later.

The positional displacement amount measurement part 31 measures the amounts of positional displacements of an optical image of a mask to be inspected and a reference image corresponding to a standard image. The positional displacement amount output part 32 outputs the measured positional displacement amounts to an external apparatus. The external apparatus corresponds to, for example, at least one of the writing apparatus 2 and the wafer exposure apparatus 4. The dimensional error amount measurement part 33 measures an amount of dimensional error between a pattern for an optical image and a pattern for a reference image, which corresponds to the former pattern. The dimensional error amount output part 34 outputs the measured amount of dimensional error to the writing apparatus 2 and the wafer exposure apparatus 4 each corresponding to the external apparatus.

The electron beam writing apparatus corresponding to the writing apparatus 2 deflects an electron beam by a deflector and applies it to the mask to thereby write each pattern onto the mask. The writing apparatus 2 includes a positional displacement amount input part 21, a deflector controller 22, a dimensional error amount input part 23 and an irradiation amount controller 24.

The positional displacement amount input part 21 inputs the positional displacement amounts outputted from the positional displacement amount output part 32 of the mask inspection apparatus 10. The deflector controller 22 controls the deflector based on the positional displacement amounts inputted to the positional displacement amount input part 21 using the known method.

The dimensional error amount input part 23 inputs the amount of dimensional error outputted from the dimensional error amount output part 34 of the mask inspection apparatus 10. The irradiation amount controller 24 controls an irradiation amount (irradiation time) of the electron beam, based on the dimensional error amount inputted to the dimensional error amount input part 23 using the known method.

A scanner corresponding to the wafer exposure apparatus 4 is equipped with a positional displacement amount input part 41, an exposure position controller 42, a dimensional error amount input part 43 and an exposure amount controller 44.

The positional displacement amount input part 41 inputs the positional displacement amounts outputted from the positional displacement amount output part 32 of the mask inspection apparatus 10. The exposure position controller 42 performs control (such as deflection control of laser light, lens control or the like) of an optical system using the known method to reduce the positional displacement amounts inputted to the positional displacement amount input part 41.

The dimensional error amount input part 43 inputs the amount of dimensional error outputted from the dimensional error amount output part 34 of the mask inspection apparatus 10. The exposure amount controller 44 controls the amount of exposure, based on the dimensional error amount inputted to the dimensional error amount input part 43 using the known method.

Incidentally, the line 1 shown in FIG. 1 has a simplified configuration in that the position measurement apparatus 303 and the measurement apparatus 306 of the conventional line 301 are not necessary.

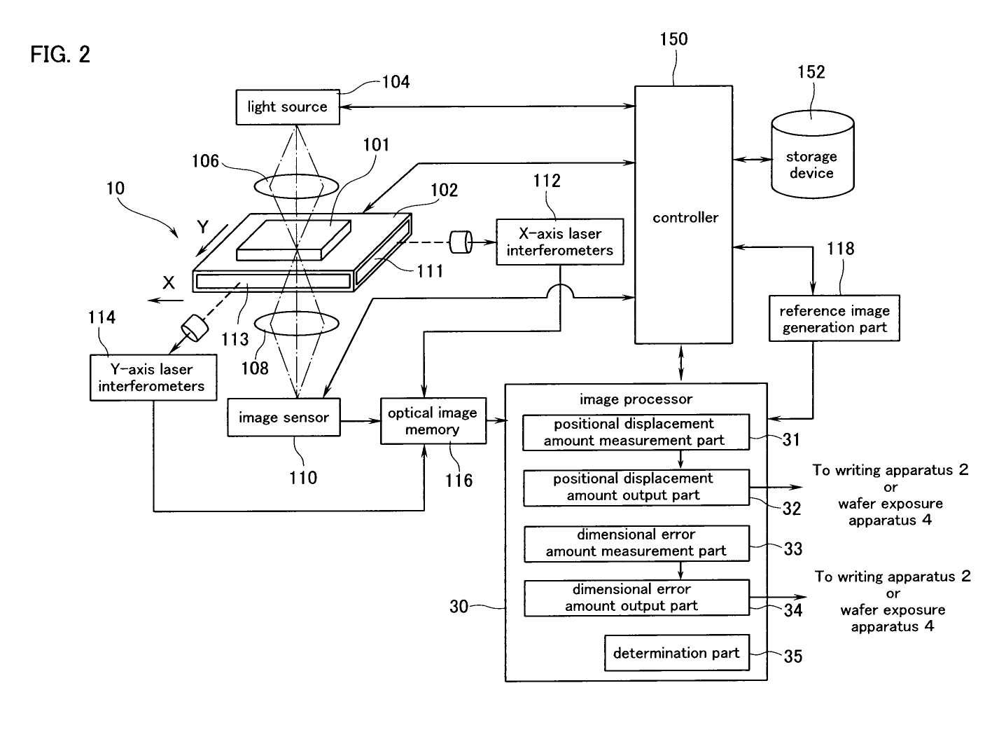

FIG. 2 is a conceptual diagram showing a configuration of the mask inspection apparatus 10 in the first embodiment of the present invention. The mask inspection apparatus 10 is equipped with a stage 102 that holds a mask 101 to be inspected thereon.

The stage 102 is drivable in X and Y directions by a motor unillustrated in the figure. Driving control of the stage 102 is executed by a controller 150. The controller 150 executes the entire control related to a mask inspection.

Mirrors 111 and 113 are respectively provided at side surfaces of the stage 102, which are parallel to the X and Y directions. An X-axis laser interferometer 112 and a Y-axis laser interferometer 114 are respectively disposed opposite to the mirrors 111 and 113.

The X-axis and Y-axis laser interferometers 112 and 114 respectively emit laser light to the mirrors 111 and 113 and receive light reflected by the mirrors 111 and 113 to thereby measure X-direction and Y-direction positions of the stage 102.

Results of measurements by the X-axis and Y-axis laser interferometers 112 and 114 are transmitted to an optical image memory 116, which in turn are used for storage of each optical image.

The mask inspection apparatus 10 is equipped with a light source 104 that emits laser light. The laser light emitted from the light source 104 is applied to the mask 101 via a contact lens 106 that configures a transmitted illumination optical system.

The laser light transmitted through the mask 101 is image-formed onto an image sensor 110 through an objective lens 108. The image sensor 110 is a TDI sensor having an imaging area of 2048 pixels×512 pixels, for example. Incidentally, the size of one pixel ranges from, for example, 70 nm×70 nm in terms of a mask surface.

Although not shown in the figure, the image sensor 110 comprises a plurality of stages (512 stages, for example) of lines arranged in a TDI direction (charge storage direction). The respective lines respectively comprise a plurality of pixels (2048 pixels, for example) arranged in the direction orthogonal to the TDI direction. Incidentally, the image sensor 110 is configured so as to be capable of outputting stored electrical charges from a dual direction.

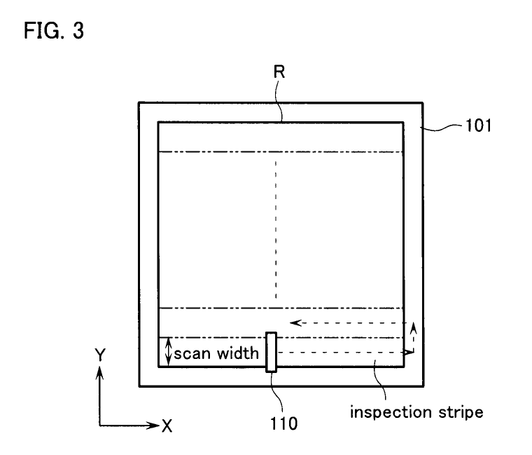

The image sensor 110 is disposed in such a manner that the TDI direction and the X direction of the stage 102 coincide with each other. Thus, when the stage 102 is moved in the X direction, the image sensor 110 is moved relative to the mask 101, so that each pattern of the mask 101 is imaged or captured by the image sensor 110 (refer to FIG. 3).

An output (optical image) corresponding to one line of the image sensor 110 is amplified by an unillustrated amplifier, followed by being stored into the optical image memory 116. At this time, the optical image corresponding to one line is stored in association with the X-direction and Y-direction positions measured by the X-axis and Y-axis laser interferometers 112 and 114.

As shown in FIG. 3, an inspected area or region R of the mask 101 is virtually divided into a plurality of inspection stripes of strip form along the Y direction. The width (scan width) of each inspection stripe is set according to the length of each line of the TDI sensor 110.

While the stage 102 is continuously moved in the X direction in a state in which the mask 101 is being held, an optical image at one of the virtually-divided inspection stripes is imaged or captured by the image sensor 110. When the end of the inspection stripe is reached, the stage 102 is moved in the Y direction. Thereafter, an optical image at the next inspection stripe is imaged by the image sensor 110 while the stage 102 is continuously moved in the opposite X direction.

By sequentially storing the optical images captured in this way in the optical image memory 116, the optical images of the entire inspected region R of the mask 101 are stored in the optical image memory 116 corresponding to an optical image acquisition part.

The mask inspection apparatus 10 is equipped with a reference image generation part 118. The reference image generation part 118 generates reference images from their corresponding design data (CAD data) stored in a storage device 152 at the generation of the mask 101.

The reference images of the mask 101 generated by the reference image generation part 118 are respectively inputted to the image processor 30.

The image processor 30 is equipped with the positional displacement amount measurement part 31, positional displacement amount output part 32, dimensional error amount measurement part 33, dimensional error amount output part 34 and determination part 35. The determination part 35 compares the amount of positional displacement between the optical image and the reference image of the mask 101 with a predetermined value and determines whether a defect exists in the mask 101.

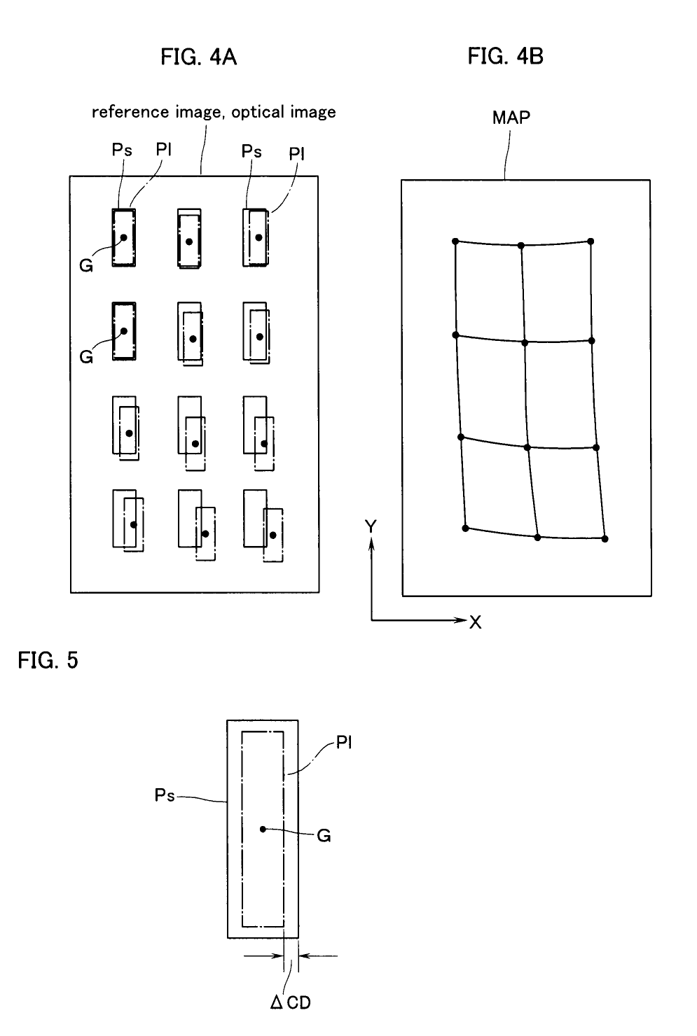

The positional displacement amount measurement part 31 measures the amount of positional displacement between each optical image and its corresponding reference image necessary for determination by the determination part 35. Described concretely, the amount of positional displacement (vector quantity) between a gravity position (not shown) of a pattern Ps of a reference image corresponding to a standard image and a gravity position G of a pattern Pl of an optical image corresponding to the pattern of the reference image is measured in FIG. 4A. In the example shown in FIG. 4A, positional displacement amounts are respectively measured at twelve points (3 points×4 points) of reference images and optical images. Using the positional displacement amounts of these twelve points, the positional displacement amount measurement part 31 fits positional displacement amounts at arbitrary coordinates in polynomial equations like, for example, 3rd order polynomial equations to thereby determine parameters of the polynomial equations.

Incidentally, although a description has been made of where the number of the measured points of positional displacement amounts is twelve for simplification of illustration, the number of measured points is not limited to it.

The method of measuring the positional displacement amounts is not limited to the above method for measuring the amount of displacement between the gravity positions, but another known method can be used.

The positional displacement amount measurement part 31 preferably creates a map (MAP) descriptive of measured amounts of positional displacements as shown in FIG. 4B. Even in the case of positional displacement amounts that cannot be described with satisfactory accuracy by the above polynomial equations, they can be described with satisfactory accuracy by using the map.

The positional displacement amount output part 32 outputs the amounts of positional displacements measured by the positional displacement amount measurement part 31 to the wafer exposure apparatus 4 corresponding to one example of the external apparatus. That is, the mask inspection apparatus 10 feeds forward the positional displacement amounts to the wafer exposure apparatus 4. When the positional displacement amounts are being fitted by the above polynomial equations, the positional displacement amount output part 32 outputs the parameters of the polynomial equations to the writing apparatus 2 or the wafer exposure apparatus 4. When the positional displacement amounts are being mapped, the positional displacement amount output part 32 outputs the map descriptive of the positional displacement amounts to the writing apparatus 2 or the wafer exposure apparatus 4.

The positional displacement amounts outputted from the positional displacement amount output part 32 are inputted to the positional displacement amount input part 21 of the writing apparatus 2 as described with reference to FIG. 1, and then inputted to the deflector controller 22. The deflector controller 22 controls the deflector based on the inputted positional displacement amount. The positional displacement amounts outputted from the positional displacement amount output part 32 are also inputted to the positional displacement amount input part 41 of the wafer exposure apparatus 4. In the wafer exposure apparatus 4, the exposure position controller 42 performs control of the optical system to reduce the positional displacement amounts inputted to the positional displacement amount input part 41 when exposure to a wafer is performed using the mask 101 in which the positional displacement amounts have been measured. The control of the optical system corresponds to the known deflection control, lens control and the like. Its detailed explanations will be omitted.

The dimensional error amount measurement part 33 of the image processor 30 measures the amount of dimensional error ΔCD between a pattern Ps for a reference image and a pattern Pl for an optical image, corresponding to the pattern Ps as shown in FIG. 5. That is, the dimensional error amount measurement part 33 measures the difference ΔCD between the dimensions of the pattern Ps and the pattern Pl. These patterns Ps and Pl are brought into alignment at their gravity positions G. Although not shown in the figure, the dimensional error amount measurement part 33 can measure dimensional error amounts ΔCD at twelve points (3 points×4 points) of reference images and optical images in a manner similar to the measurement of the positional displacement amounts by the positional displacement amount measurement part 31. Then, the dimensional error amounts ΔCD at the twelve points are fitted in polynomial equations like, for example, 3rd order polynomial equations to determine parameters of the polynomial equations.

The dimensional error amount measurement part 33 preferably creates a map descriptive of the measured dimensional error amounts ΔCD. Even in the case of dimensional error amounts that cannot be described with satisfactory accuracy by the above polynomial equations, they can be described with satisfactory accuracy by using the map.

The dimensional error amounts outputted from the dimensional error amount output part 34 are inputted to the dimensional error amount input part 23 of the writing apparatus 2 and then inputted to the irradiation amount controller 24 as described with reference to in FIG. 1. The irradiation amount controller 24 controls the amount of irradiation (irradiation time) of the electron beam, based on the inputted dimensional error amount. The dimensional error amounts outputted from the dimensional error amount output part 34 are also outputted to the dimensional error amount input part 43 of the wafer exposure apparatus 4. That is, the mask inspection apparatus 10 feeds forward the dimensional error amounts ΔCD to the wafer exposure apparatus 4. When the dimensional error amounts ΔCD are being fitted by the above polynomial equations, the dimensional error amount output part 34 outputs the parameters of the polynomial equations to the wafer exposure apparatus 4. When the dimensional error amounts are being mapped, the dimensional error amount output part 34 outputs the map descriptive of the dimensional error amounts to the wafer exposure apparatus 4.

The dimensional error amounts outputted from the dimensional error amount output part 34 are inputted to the dimensional error amount input part 43 of the wafer exposure apparatus 4 (refer to FIG. 1). In the wafer exposure apparatus 4, the exposure amount controller 44 performs control of the amount of exposure to reduce the dimensional error amounts ΔCD when exposure to the wafer is performed using the mask 101 in which the dimensional error amounts ΔCD have been measured. That is, the size of each pattern formed in the wafer is controlled to be a desired size (size of pattern Ps for reference image) by variably controlling the amount of exposure (exposure time). Since the control on the amount of exposure is known, its detailed explanations are omitted.

The positional displacement amount output part 32 outputs the amount of positional displacement even to the writing apparatus 2 corresponding to another example of the external apparatus (refer to FIG. 1). That is, the mask inspection apparatus 10 feeds back the parameters of the polynomial equations with the positional displacement amounts fitted therein and the map descriptive of the positional displacement amounts to the writing apparatus 2. Thus, the position measurement apparatus 303 of the conventional line 301 becomes unnecessary and the configuration of the line 1 can hence be simplified.

The positional displacement amounts outputted from the positional displacement amount output part 32 are inputted to the positional displacement amount input part 21 of the writing apparatus 2 (refer to FIG. 1). When each pattern is written onto another mask after writing for the mask in which the positional displacement amounts have been measured, the deflector controller 22 controls the deflector using the positional displacement amounts in the writing apparatus 2. Thus, the writing position accuracy of the writing apparatus 2 can be enhanced.

The dimensional error amount output part 34 outputs the amount of dimensional error even to the dimensional error amount input part 23 of the writing apparatus 2 (refer to FIG. 1). That is, the mask inspection apparatus 10 feeds back the parameters of the polynomial equations in which the amounts of dimensional error have been fitted, and the map descriptive of the dimensional error amounts to the writing apparatus 2.

Each of the dimensional error amounts outputted from the dimensional error amount output part 34 is inputted to the dimensional error amount input part 23 of the writing apparatus 2 (refer to FIG. 1). When each pattern is written onto another mask after writing for the mask in which the dimensional error amounts have been measured, the irradiation amount controller 24 controls the amount of irradiation (irradiation time) using the dimensional error amounts in the writing apparatus 2.

When the amount of positional displacement between each optical image and its corresponding reference image of the mask 101, which has been measured by the positional displacement amount measurement part 31, is larger than a predetermined standard value or when the dimensional error amount ΔCD measured by the dimensional error amount measurement part 33 is larger than a predetermined standard value, a defect exists in the mask 101. Therefore, the determination part 35 determines the mask as a defective item.

In the first embodiment as described above, the amount of positional displacement between each reference image and its corresponding optical image of the mask 101 is measured by the positional displacement amount measurement part 31 of the mask inspection apparatus 10. The measured amount of positional displacement is outputted to the wafer exposure apparatus 4 by the positional displacement amount output part 32. The wafer exposure apparatus 4 inputs the amount of positional displacement and controls the optical system to reduce the inputted amount of positional displacement, thereby enabling exposure to the wafer. Thus, since the positional displacement amount of each pattern formed in the wafer can be reduced, the yield of a semiconductor device can be improved. Further, since the temporary exposure which has heretofore been performed to determine the amount of positional displacement becomes unnecessary, the number of steps is reduced and it is hence possible to shorten the time taken until the start of mass production by the wafer exposure apparatus 4 using the mask having passed the defect inspection of the mask inspection apparatus 10. According to the first embodiment, although it was necessary to measure the amount of dimensional error between the micro patterns scaled-down and projected where the conventional temporary exposure is performed, the amount of dimensional error can be determined with satisfactory accuracy because the amount of dimensional error between the patterns in the mask is measured.

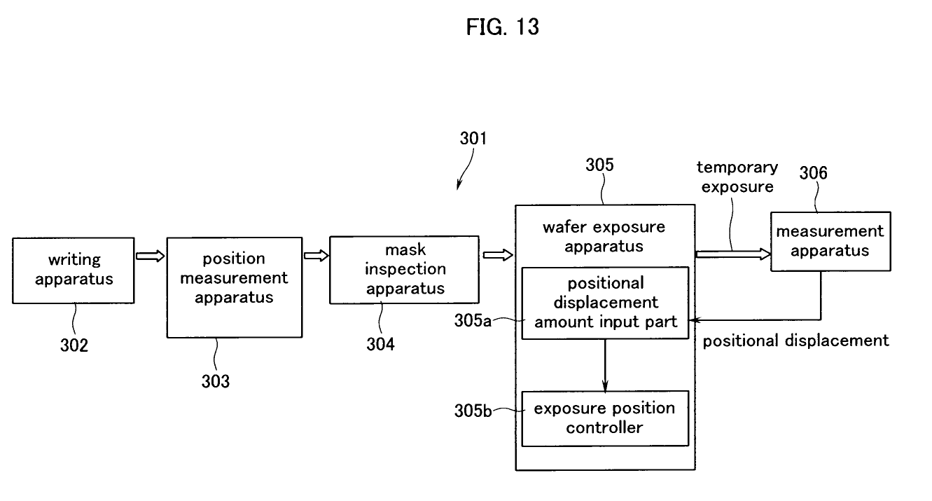

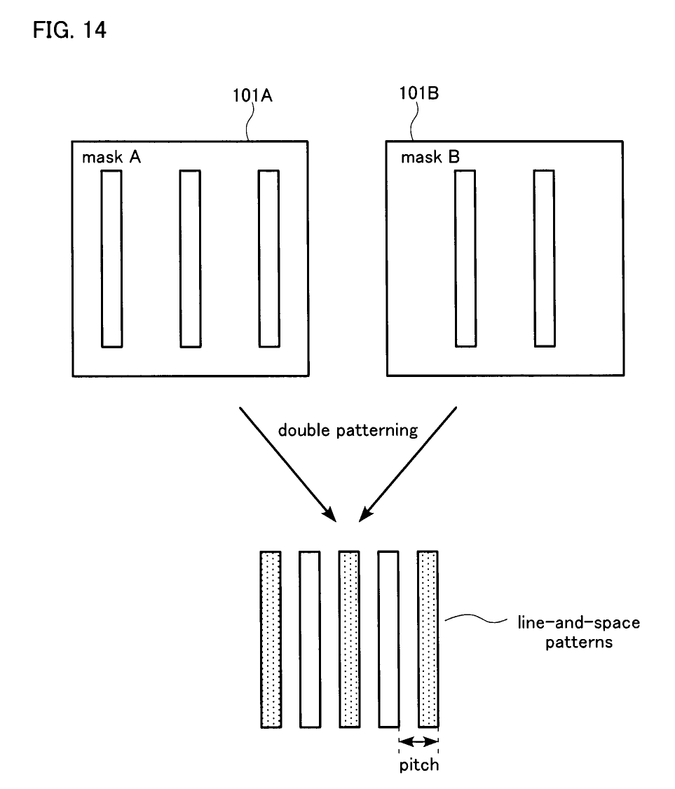

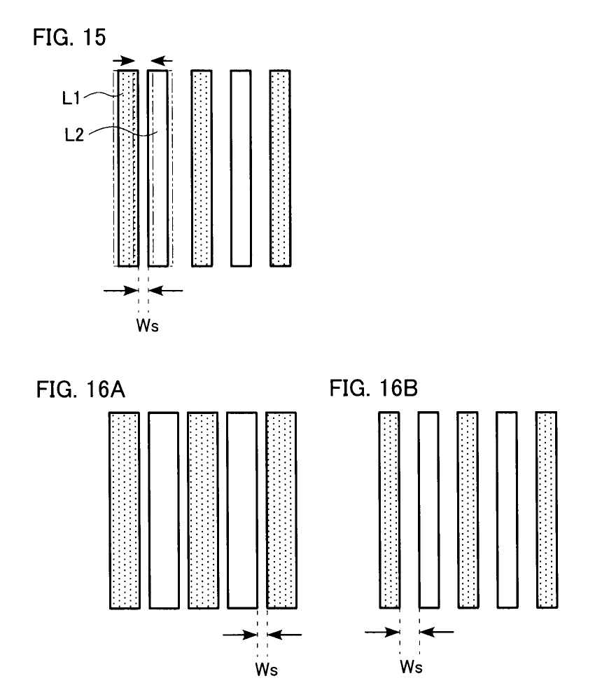

In the first embodiment, the positional displacement amount output part 32 outputs the measured positional displacement amounts to the writing apparatus 2. The writing apparatus 2 inputs the positional displacement amounts, controls the deflector by the deflector controller 22 based on the inputted positional displacement amounts and writes each pattern for the mask, thereby making it possible to enhance the writing position accuracy. Further, since the localization or position measurement (the measurement of position by the position measurement apparatus 303 shown in FIG. 13) that has heretofore been performed before the defect inspection by the mask inspection apparatus 10 after the writing by the writing apparatus 2 becomes unnecessary, the number of steps is reduced and hence the time taken until the start of mass production can be shortened by the wafer exposure apparatus 4. Since the number of points measured by the mask inspection apparatus 10 is far greater than the number of points measured by the position measurement apparatus 303, the detailed amounts of positional displacement can be inputted to the writing apparatus 2 and hence the writing position accuracy can be enhanced.

A second embodiment in which the present invention is applied to a mask for double patterning will next be explained.

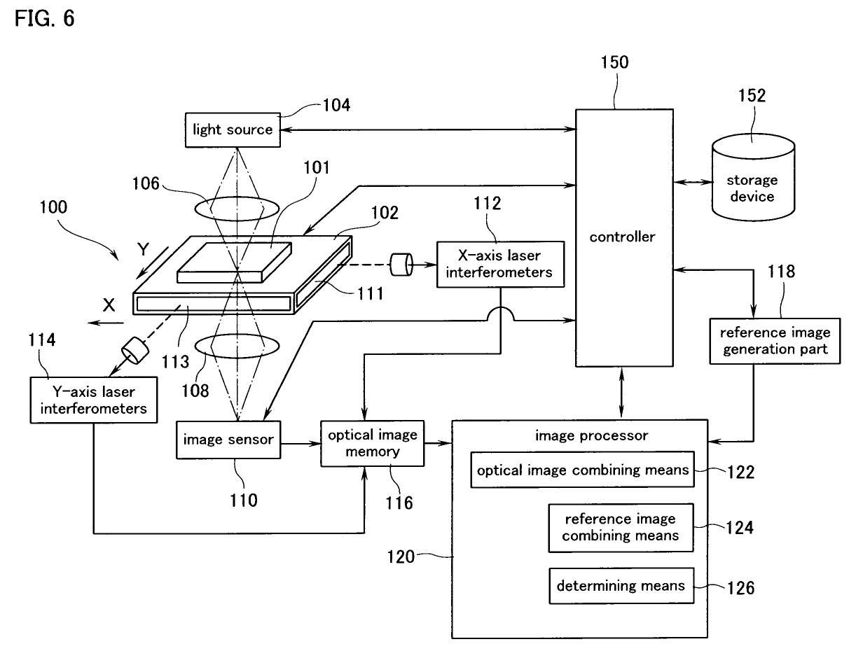

FIG. 6 is a conceptual diagram showing a configuration of a mask inspection apparatus 100 according to the second embodiment of the present invention. The mask inspection apparatus 100 is different from the mask inspection apparatus 10 shown in FIG. 2 in that it is equipped with an image processor 120 instead of the image processor 30. Since the mask inspection apparatus 100 is similar in other configuration to the mask inspection apparatus 10, the detailed description thereof is omitted.

A first mask 101A used in double patterning is placed on a stage 102. Optical images in the entire inspected area or region R of the mask 101A are stored in an optical image memory 116. Thereafter, the mask 101A is replaced with a second mask 101B used in double patterning. Optical images in the entire inspected region R of the mask 101B are stored in the optical image memory 116 using a similar method.

The reference image generation part 118 generates reference images from their corresponding design data (CAD data) stored in a storage device 152 at the generation of the masks 101A and 101B.

The reference images of the two masks 101A and 101B, which have been generated by the reference image generation part 118, are respectively inputted to the image processor 120.

The image processor 120 is equipped with optical image combining means 122, reference image combining means 124 and determining means 126.

The optical image combining means 122 reads the optical images of the two masks 101A and 101B used in double patterning, respectively, from the optical image memory 116 and combines them while they are being brought into alignment by a method to be described later.

The reference image combining means 124 combines the reference images of the two masks 101A and 101B, which have been inputted from the reference image generation part 118.

The determining means 126 measures relative positional displacement amounts of patterns of plural masks 101A and 101B at optical images combined by the optical image combining means 122. In a combined image of line-and-space patterns shown in FIG. 8, for example, the width Rab of space defined between a line pattern of each mask 101A and a line pattern of each mask 101B is measured at plural points by the determining means 126.

The determining means 126 measures relative positional displacement amounts of patterns of plural masks 101A and 101B as standard values similarly even at the reference images combined by the reference image combining means 124.

Further, the determining means 126 compares the positional displacement amounts Rab measured at the plural points in the combined optical image and the standard values at the points corresponding to the measurement points at the combined reference image respectively and determines according to a predetermined determination rule whether the masks 101A and 101B are good.

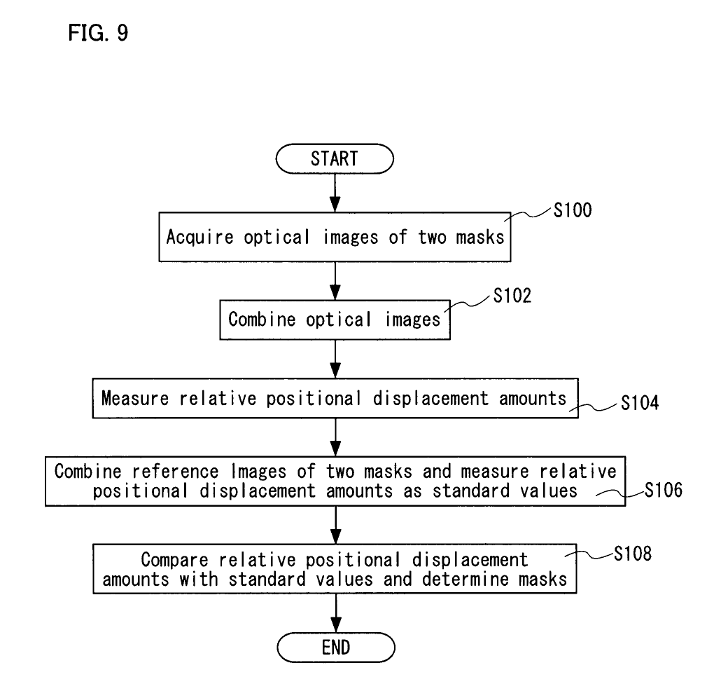

A mask inspection method according to the second embodiment will next be explained with reference to FIG. 9. A routine shown in FIG. 9 is executed by a controller 150.

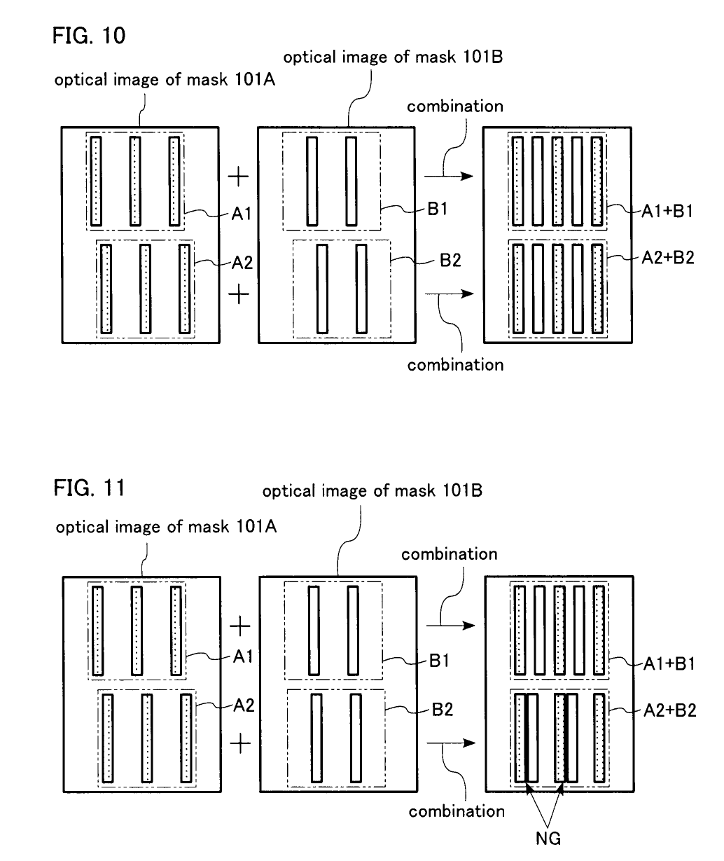

According to the routine shown in FIG. 9, optical images of two masks 101A and 101B used in double patterning shown in FIG. 10 are first acquired (Step S100). At Step S100, the optical images of the two masks 101A and 101B, which are imaged or captured by an image sensor 110 and stored in the optical image memory 116, are read into the image processor 120.

Next, the optical images of the masks 101A and 101B, which have been acquired at Step S100 referred to above, are combined together while being brought into alignment by the optical image combining means 122 (Step S102).

Here, the term “alignment” means that the positional displacements of patterns at the acquired optical images are minimized by translating and rotating them.

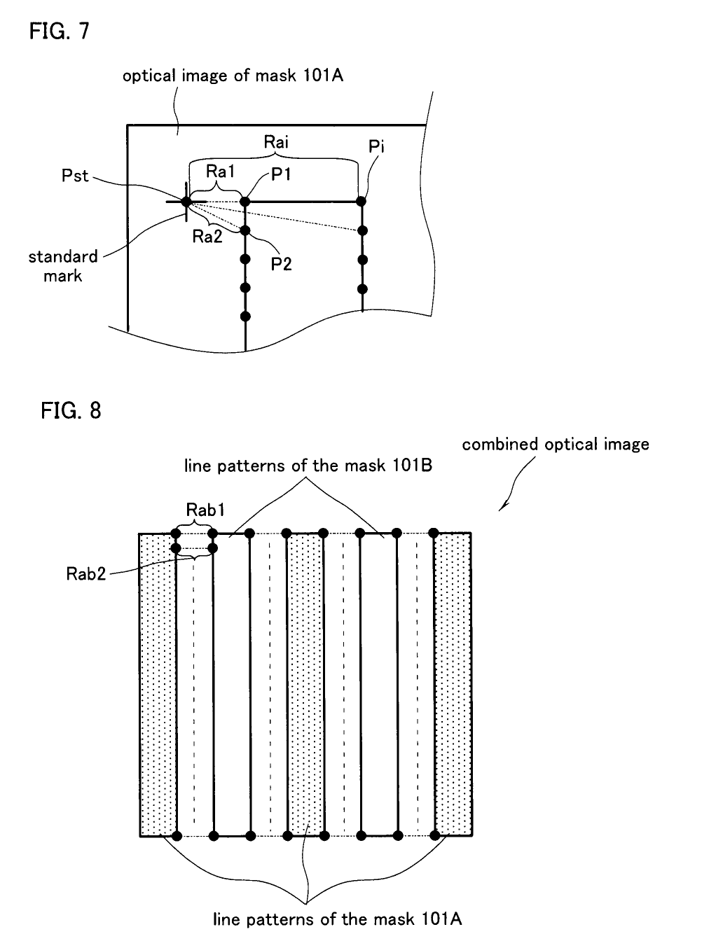

At Step S102, the positional displacement amounts of patterns necessary for alignment are first determined from the optical images. As shown in FIG. 7, an optical image of a mask 101A includes a cross standard mark. The center of the standard mark is assumed to be a standard point Pst.

Distances Ra1, Ra2, . . . , Ri from the standard point Pst to a plurality of measurement points P1, P2, . . . , Pi, . . . of pattern edges are respectively measured.

Subsequently, differences ΔRa1, . . . between the measured distances Ra1, . . . and their designed values ra1, . . . are determined in accordance with the following equation (1). The determined differences ΔRa1, . . . become positional displacement amounts of the patterns at the respective measurement points.

ΔRa=Ra−ra (1)

Alignment amounts (i.e., translational and rotational amounts) for minimizing the average value of the positional displacement amounts ΔRa at the respective measurement points are determined by the known method.

In accordance with a method similar to the above method, distances Rb from a standard point to a plurality of measurement points are measured at an optical image of another mask 101B, and differences ΔRb between the measured distances Rb and their corresponding designed values rb are determined as positional displacement amounts. Alignment amounts (translational and rotational amounts) for minimizing the average value of the positional displacement amounts ΔRb at the respective measurement points are determined.

Next, the two optical images are combined together while they are brought into alignment using the determined alignment amounts. An example of the combined image is shown in FIG. 8.

Subsequently, the relative positional displacement amounts (hereinafter called “relative positional displacement amounts”) of each pattern of the mask 101A and each pattern of the mask 101B are measured at the optical image combined at Step S102 referred to above (Step S104). In the example shown in FIG. 8, intervals Rab1, Rab2, . . . each corresponding to space defined between the line patterns of the mask 101A and the line patterns of the mask 101B are measured at plural points.

Next, standard values compared with the relative positional displacement amounts measured at Step S104 referred to above are determined (Step S106).

At Step 5106, the reference images of the two masks 101A and 101B, which have been inputted from the reference image generation part 118, are first combined by the reference image combining means 124. For example, a combined image of reference images, which is to be contrasted with the combined image of optical images shown in FIG. 8, is generated.

At the combined reference image, the relative positional displacement amounts of each pattern of the mask 101A and each pattern of the mask 101B are measured at plural points as standard values. The points where the standard values are measured correspond to the measurement points at Step S104 referred to above.

Finally, the respective relative positional displacement amounts measured at Step S104 and the standard values measured at Step S106 are compared. It is determined according to a predetermined determination rule whether the two masks 101A and 101B are good (Step S108). When the difference between each of the relative positional displacement amounts and each of the standard values is greater than or equal to a predetermined value, the two masks 101A and 101B are determined to be defective at Step S108.

After the process of Step S108, the present routine is completed.

In the second embodiment as described above, the optical images of the two masks 101A and 101B are combined together. It is determined based on the relative positional displacement amounts of the patterns of the masks 101A and 101B at the combined image whether the masks 101A and 101B are good or not. It is thus possible to inspect the two masks 101A and 101B used in double patterning with satisfactory accuracy.

Incidentally, the present invention is not limited to the above embodiments. The present invention can be modified in various ways within the scope not departing from the gist of the present invention.

Although the positional displacement amounts and dimensional error amounts measured by the mask inspection apparatus 10 are outputted to the wafer exposure apparatus 4 and the writing apparatus 2 each corresponding to the external apparatus in the first embodiment, they may be outputted to an etching apparatus and a deposition apparatus or the like each corresponding to another external apparatus.

Although the optical images are acquired using the transmitted illumination system in the first and second embodiments, for example, the present invention is not limited to it, but can be applied even to the case where optical images are acquired using a reflected illumination system.

Although the second embodiment has explained the example in which the two masks 101A and 101B are inspected, the present invention can be applied even to the case in which three or more masks are inspected.

Although the example of the Die-to-Database inspection has been explained in the first and second embodiments, the present invention can be applied to the Die-to-Die inspection.

Assume that the same patterns are written onto two masks 101A and 101B for double patterning at two points as shown in FIGS. 10 and 11. When the present invention is applied to the inspection of these two masks 101A and 101B, a relative positional displacement amount of a combined image A1+B1 of both images A1 and B1 and a relative positional displacement amount of a combined image A2+B2 of both images A2 and B2 are compared with each other. Any of the relative positional displacement amounts is taken as a standard value upon comparison/determination.

When the relationship of position between the images A1 and A2 at the optical image of the mask 101A and the relationship of position between the images B1 and B2 at the optical image of the mask 101B are equal to each other as shown in FIG. 10 here, the relative positional displacement amount of the combined image A1+B1 and the relative positional displacement amount of the combined image A2+B2 can be compared with each other.

That is, since an alignment amount taken when the images A1 and B1 are combined together and an alignment amount taken when the images A2 and B2 are combined together, are common, the relative positional displacement amounts can be compared after the alignment.

On the other hand, when the relationship of position between the images A1 and A2 at the optical image of the mask 101A and the relationship of position between the images B1 and B2 at the optical image of the mask 101B are different from each other as shown in FIG. 11, alignment amounts at the time that the optical images are combined as mentioned above are common. Therefore, each relative positional displacement amount of a combined image A1+B1 subsequent to the alignment and each relative positional displacement amount of a combined image A2+B2 subsequent to the common alignment are compared with each other. As a result, the masks are determined to be defective.

Although the second embodiment has described the example in which the mask inspection is performed using one inspection apparatus, the present invention can be applied even to the case where a mask inspection is performed using two or more inspection apparatuses.

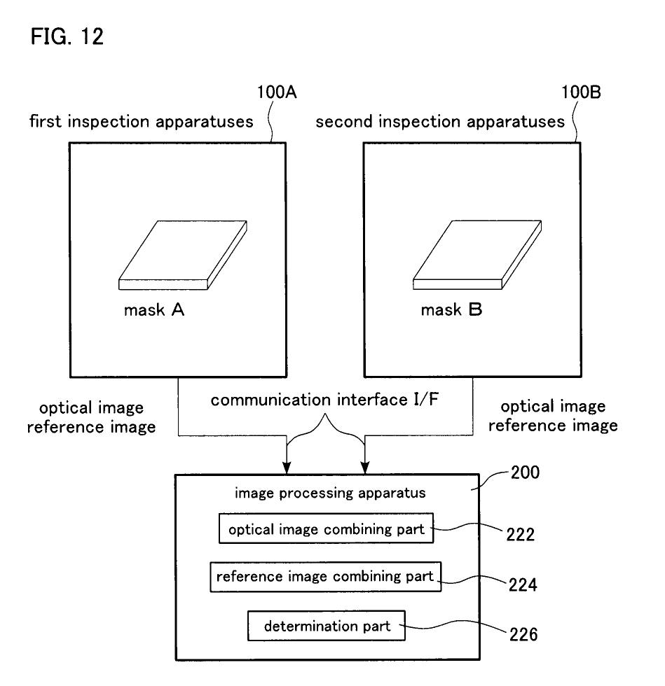

FIG. 12 shows an example in which mask inspections are performed using two inspection apparatuses 100A and 100B. That is, an image processing apparatus 200 is connected to the two inspection apparatuses 100A and 100B via a communication interface (I/F). Incidentally, a GbitEther, an InfiniBand or the like can be used as the communication I/F.

The image processing apparatus 200 has the same function as the image processor 120 and is equipped with an optical image combining part 222, a reference image combining part 224 and a determination part 226. Incidentally, the image processing apparatus 200 may be configured so as to share either one of image processors 120 in the inspection apparatuses 100A and 100B.

The features and advantages of the present invention may be summarized as follows.

According to the first aspect of the present invention, the temporary exposure which has heretofore been conducted to determine the positional displacement amounts becomes unnecessary by measuring the positional displacement amounts of the optical and reference images by means of the positional displacement amount measurement part and outputting the measured positional displacement amounts to the wafer exposure apparatus. Thus, it is possible to shorten the time taken until mass production is started by the wafer exposure apparatus using the mask having passed the defect inspection of the mask inspection apparatus. According to the first aspect as well, the position measurement, which has been conducted to determine the positional displacement amounts after writing, becomes unnecessary by outputting the measured positional displacement amounts to the writing apparatus. It is therefore possible to shorten the time taken until writing is conducted based on the positional displacement amounts.

In the second aspect of the present invention, the positional displacement amounts measured using the mask inspection apparatus of the first aspect are inputted to the positional displacement amount input part of the wafer exposure apparatus to thereby perform exposure to the wafer. Therefore, the temporary exposure which has heretofore been performed to determine the positional displacement amounts becomes unnecessary. It is thus possible to shorten the time taken until mass production is started by the wafer exposure apparatus using the mask having passed the defect inspection of the mask inspection apparatus.

In the third aspect of the present invention, the optical images of the plural masks are combined together by the optical image combining part, the relative positional displacement amounts of the patterns in the masks at the combined image are measured by the positional displacement amount measurement part, and the measured positional displacement amounts are compared with their corresponding standard values. Thus, according to the first aspect, the inspection of the two masks used in double patterning can be conducted with satisfactory accuracy.

In the fourth aspect of the present invention, the optical images of the first and second masks for double patterning are combined together while they are being brought into alignment. The relative positional displacement amounts of each pattern of the first mask and each pattern of the second mask are measured at the combined image. The measured positional displacement amounts are compared with their corresponding standard values. According to the second aspect, the inspection of the two masks used in double patterning can be conducted with satisfactory accuracy.

Obviously many modifications and variations of the present invention are possible in the light of the above teachings. It is therefore to be understood that within the scope of the appended claims the invention may be practiced otherwise than as specifically described.

The entire disclosure of Japanese Patent Applications No. 2008-242596, filed on Sep. 22, 2008 and No. 2009-34570, filed on Feb. 17, 2009, including specifications, claims, drawings and summaries, on which the Convention priority of the present application are based, are incorporated herein by reference in their entirety.

What is claimed is:

1. A mask inspection apparatus comprising:
an optical image acquisition part for acquiring optical images of a mask;
a reference image generation part for generating reference images of the mask from design data of the mask;
a positional displacement amount measurement part for measuring positional displacement amounts between the optical and reference images; and
a positional displacement amount output part for outputting the positional displacement amounts to a wafer exposure apparatus and/or a writing apparatus.

2. The mask inspection apparatus according to claim 1, further comprising:
a dimensional error amount measurement part for measuring the amount of dimensional error between each of patterns at the optical images and each of patterns at the reference images, and
a dimensional error amount output part for outputting the dimensional error amounts to the wafer exposure apparatus and/or the writing apparatus.

3. The mask inspection apparatus according to claim 2, wherein the dimensional error amount measurement part brings the dimensional error amounts into map form.

4. The mask inspection apparatus according to claim 1, wherein the positional displacement amount measurement part brings the positional displacement amounts into map form.

5. The mask inspection apparatus according to claim 4, further comprising:
a dimensional error amount measurement part for measuring the amount of dimensional error between each of patterns at the optical images and each of patterns at the reference images, and
a dimensional error amount output part for outputting the dimensional error amounts to the wafer exposure apparatus and/or the writing apparatus.

6. The mask inspection apparatus according to claim 2, wherein the dimensional error amount measurement part brings the dimensional error amounts into map form.

7. An exposure method comprising:
acquiring positional displacement amounts between optical images of a mask and reference images obtained from design data of the mask by the mask inspection apparatus according to claim 1;
inputting the acquired positional displacement amounts to an exposure apparatus; and
controlling an optical system of the exposure apparatus based on the inputted positional displacement amounts to thereby perform exposure to a wafer.

8. The exposure method according to claim 7, further comprising acquiring a difference between a dimension of a pattern at each optical image of the mask and a dimension of a pattern at each reference image obtained from the design data of the mask by the mask inspection apparatus according to claim 1;
inputting the acquired difference to the exposure apparatus; and
controlling an exposure amount of the exposure apparatus based on the inputted difference to thereby perform the exposure.

9. A mask inspection apparatus comprising:
an optical image acquisition part for acquiring optical images of a plurality of masks;
an optical image combining part for combining the optical images of the masks, which have been acquired by the optical image acquisition part;
a positional displacement amount measurement part for measuring relative positional displacement amounts of patterns of the masks at an image combined by the optical image combining part; and
a comparison part for comparing the positional displacement amounts measured by the positional displacement amount measurement part with standard values respectively.

10. The mask inspection apparatus according to claim 9, further comprising a reference image generation part for generating reference images of the masks from design data of the masks; and
a reference image combining part for combining the reference images of the masks generated by the reference image generation part,
wherein the comparison part calculates relative positional displacement amounts of patterns of the masks at an image combined by the reference image combining part as the standard values.

11. A mask inspection method for inspecting first and second masks for double patterning, comprising:
acquiring optical images of the first and second masks respectively;
combining the optical image of the first mask and the optical image of the second mask while they are being brought into alignment;
measuring relative positional displacement amounts of each pattern of the first mask and each pattern of the second mask at the combined image; and
comparing the measured positional displacement amounts with standard values respectively.

12. The mask inspection method according to claim 11,
wherein optical images of line patterns of the first mask are combined with optical images of line patterns of the second mask,
wherein the width of space defined between each of the line patterns of the first mask and each of the line patterns of the second mask is measured, and
wherein the width of the space is compared with each of the standard values to thereby determine whether each of the first and second masks is good or not.

13. The mask inspection method according to claim 11, further comprising
generating reference images of the first and second masks from design data of the first and second masks respectively;
combining the reference images of the first and second masks; and
calculating relative positional displacement amounts of each pattern of the first mask and each pattern of the second mask as the standard values at the combined image.

14. The mask inspection method according to claim 13,
wherein optical images of line patterns of the first mask are combined with optical images of line patterns of the second mask,
wherein the width of space defined between each of the line patterns of the first mask and each of the line patterns of the second mask is measured, and
wherein the width of the space is compared with each of the standard values to thereby determine whether each of the first and second masks is good or not.
